(19) United States
(12) Patent Application Publication
(10) Pub. No.: US 2021/0300806 A1
(43) Pub. Date: Sep. 30, 2021

(54) METHOD AND APPARATUS FOR REUSING WASTEWATER BY USING REVERSE OSMOSIS

(71) Applicants: POSCO, Pohang-si, Gyeongsangbuk-do (KR); RESEARCH INSTITUTE OF INDUSTRIAL SCIENCE & TECHNOLOGY, Pohang-si, Gyeongsangbuk-do (KR)

(72) Inventors: Shin-Gyung Kang, Gwangyang-si, Jeollanam-do (KR); Youl-Boong Sung, Gwangyang-si, Jeollanam-do (KR)

(21) Appl. No.: 17/260,506

(22) PCT Filed: Jul. 18, 2019
(86) PCT No.: PCT/KR2019/008907

§ 371 Date: Jan. 14, 2021

(30) Foreign Application Priority Data
Jul. 18, 2018 (KR) 10-2018-0083459

(51) Int. Cl. C02F 9/00; B01D 61/02; B01D 61/08; B01D 61/06; B01D 61/14; B01D 61/58; B01D 61/04; B01D 61/18; B01D 65/02

(52) U.S. Cl. CPC C02F 9/00; B01D 61/025; B01D 61/08; B01D 61/06; B01D 61/022; C02F 2103/04; B01D 61/58; B01D 61/04; B01D 61/18; B01D 65/02; C02F 2301/08; B01D 61/145

(57) ABSTRACT

A method for reusing wastewater by using reverse osmosis, according to the present invention, provides a method for preparing pure water through a primary reverse osmosis step, a secondary reverse osmosis step, a foam generation step, and a reverse osmosis membrane washing step. The present invention prepares pure water through several reverse osmosis steps, thereby enabling prepared pure water to be immediately used as industrial water, and washes a reverse osmosis membrane with foam, thereby improving washing efficiency and saving on maintenance costs of a wastewater reuse apparatus.

### TECHNICAL FIELD

The present disclosure relates to a method and apparatus for reusing wastewater as industrial water using reverse osmosis.

### BACKGROUND ART

As clean and usable water decreases due to frequent droughts and water pollution caused by climate change, water scarcity is likely to be intensified in the future. In July 2008, the United Nations (UN) predicted that the world population under water scarcity would reach 3 billion by 2025 from 700 million at the time. In Korea, since precipitation per capita (2,591 tons per year) is about ⅛ of the world average, and in particular, river intake rate is 36%, Korea also belongs in a category of countries with high water stress and is vulnerable to water use during droughts. In preparation therefor, as a method for securing alternative water, a method for desalinating sea water or reusing sewage and wastewater is widely used.

A cost required to reuse wastewater varies, depending on a reuse method, process configuration, facility introduction location, water quality required for raw water and finally produced water, and the like, and it is determined that, in the case of a reverse osmosis method, the required cost is in a range of $0.5 to $1.5 per ton of permeate water. Facility investment and electricity costs need to be lowered to lower the cost of reusing reverse osmosis wastewater.

To this end, Patent Document 1 (10-1794195) discloses a sewage and wastewater reuse system including a precipitation and filtration device, the precipitation and filtration device including: a housing having a floating medium made of an ethylene-vinyl acetate (EVA) material and embedded inside a main body as a unit, and an upper screen formed on an upper surface; a precipitation section consisting of a plurality of inclined plates and formed at a lower portion; and a moving cart provided at an upper portion and a unit for cleaning and sucking a medium.

Patent Document 2 (10-1036880) discloses a reverse osmosis membrane apparatus provided with a catalytic oxidation device that decomposes organic substances in discharged treated water by catalytic oxidation. Patent Document 3 (10-1720460) discloses a continuous washing agent for a reverse osmosis membrane, containing: a decomposer containing an organic acid, a peracetic acid, hydrogen peroxide, an anionic surfactant, and a polymeric dispersant; and a decomposition accelerator containing an alkaline compound, an organic chelating agent, and an organic amine.

### RELATED ART DOCUMENT

### Patent Document

Korean Patent No. 10-1794195

Korean Patent No. 10-1036880

Korean Patent No. 10-1720460

### DISCLOSURE

### Technical Problem

An object of the present disclosure is to provide a reverse osmosis system for producing pure water using wastewater, a highly efficient wastewater reuse system capable of reducing a membrane replacement cost by reducing power consumption using an energy recovery device and improving membrane washing efficiency by explosion power and washing power of bubbles generated by adding a bubble generation device to a membrane washing device.

### Technical Solution

According to an aspect of the present disclosure, a method for reusing wastewater includes: a primary reverse osmosis operation of feeding wastewater to a primary reverse osmosis pressure vessel and discharging primary concentrated water and primary permeate water; a secondary reverse osmosis operation of feeding the primary permeate water to a secondary reverse osmosis pressure vessel and discharging secondary concentrated water and pure water; a bubble generation operation of generating bubbles by mixing air and a washing liquid with each other; and a reverse osmosis membrane washing operation of washing a reverse osmosis membrane by feeding the washing liquid including the bubbles to the primary reverse osmosis pressure vessel.

The method may further include: a primary pre-treatment operation of discharging primary pre-treated water from which floating substances and organic substances in the wastewater are removed; and a secondary pre-treatment operation of removing fine particles included in the primary pre-treated water and feeding the primary pre-treated water to the primary reverse osmosis pressure vessel.

The primary reverse osmosis operation may include a primary first stage reverse osmosis operation and a primary second stage reverse osmosis operation.

The method may further include an energy recovery operation of rotating a turbine of an energy recovery device using pressure of concentrated water discharged in the primary second stage reverse osmosis operation.

The secondary reverse osmosis operation may include a secondary first stage reverse osmosis operation and a secondary second stage reverse osmosis operation.

According to another aspect of the present disclosure, an apparatus for reusing wastewater includes: a primary reverse osmosis pressure vessel separating wastewater and discharging primary concentrated water and primary permeate water; a secondary reverse osmosis pressure vessel separating the primary permeate water and discharging secondary concentrated water and pure water; and a line mixer generating bubbles by mixing air and a washing liquid with each other.

The apparatus may further include: a primary pre-treatment device discharging primary pre-treated water from which floating substances and organic substances in the wastewater are removed; and a secondary pre-treatment device removing fine particles included in the primary pre-treated water.

The primary reverse osmosis pressure vessel may include a primary first stage reverse osmosis pressure vessel and a primary second stage reverse osmosis pressure vessel.

The apparatus may further include an energy recovery device whose turbine is rotated using pressure of concentrated water discharged from the primary second stage reverse osmosis pressure vessel.

The secondary reverse osmosis pressure vessel may include a secondary first stage reverse osmosis pressure vessel and a secondary second stage reverse osmosis pressure vessel.

### Advantageous Effects

A regenerating chemical such as hydrochloric acid or caustic soda has been essentially used in a pure water production device using an ion-exchange resin method according to the related art.

However, according to the reverse osmosis wastewater reuse system according to the present disclosure, since final permeate water purified by reverse osmosis may be immediately used as pure water, there is no need to use the regenerating chemical described above, and energy consumption may be reduced using a surplus pressure of the primary concentrated water as a boosting pressure.

In addition, washing efficiency is improved by washing the reverse osmosis membrane with the washing liquid including bubbles, which enables an increase in the amount of reverse osmosis membrane permeate water and an extension of a period of use of the reverse osmosis membrane. Thus, maintenance costs of the apparatus for reusing wastewater may be saved.

### DESCRIPTION OF DRAWINGS

FIG. 1 is a schematic view illustrating a reverse osmosis wastewater reuse system according to an exemplary embodiment in the present disclosure.

FIGS. 2 and 3 are diagrams illustrating simulation results of the reverse osmosis wastewater reuse system according to an exemplary embodiment in the present disclosure.

FIG. 4 is a diagram illustrating fluxes of reverse osmosis membranes according to a washing liquid.

### BEST MODE FOR INVENTION

Various advantages and features of the present disclosure and methods accomplishing them will become apparent from the following description of exemplary embodiments with reference to the accompanying drawings. However, the present disclosure is not limited to exemplary embodiments to be described below, but may be implemented in various different forms, these exemplary embodiments will be provided only in order to make the present disclosure complete and allow those skilled in the art to completely recognize the scope of the present disclosure, and the present disclosure will be defined by the scope of the claims. Throughout the specification, like reference numerals denote like elements.

Hereinafter, a method for reusing wastewater according to an exemplary embodiment in the present disclosure will be described.

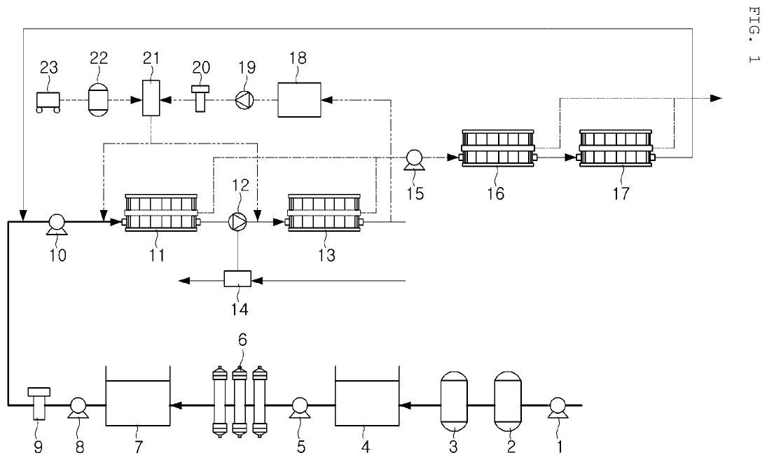

FIG. 1 is a schematic view illustrating a reverse osmosis wastewater reuse system according to an exemplary embodiment in the present disclosure.

The method for reusing wastewater according to an exemplary embodiment in the present disclosure includes: a primary reverse osmosis operation of feeding wastewater to primary reverse osmosis pressure vessels 11 and 13 and discharging primary concentrated water and primary permeate water; a secondary reverse osmosis operation of feeding the primary permeate water to secondary reverse osmosis pressure vessels 16 and 17 and discharging secondary concentrated water and pure water; a bubble generation operation of generating bubbles by mixing air fed from an air storage tank and a washing liquid with each other; and a reverse osmosis membrane washing operation of washing a reverse osmosis membrane by feeding a washing liquid including bubbles to the primary reverse osmosis pressure vessels.

In the primary reverse osmosis operation, the wastewater is pressurized by a primary reverse osmosis high-pressure pump 10 and fed to the primary reverse osmosis pressure vessels, and ions included in the wastewater are removed by reverse osmosis. The primary permeate water from which ions are removed is fed to the secondary reverse osmosis pressure vessels, and the primary concentrated water is discharged.

In the secondary reverse osmosis operation, trace amounts of ions included in the primary permeate water are removed by reverse osmosis in the secondary reverse osmosis pressure vessels and discharged as pure water, and the secondary concentrated water discharged from the secondary reverse osmosis pressure vessels is fed to the primary reverse osmosis pressure vessels again together with the wastewater.

Meanwhile, in the present disclosure, as an operating time of an apparatus for reusing wastewater passes, the reverse osmosis pressure vessel and the reverse osmosis membrane are contaminated with contaminants in the wastewater, resulting in an increase in operating pressure and a decrease in amount of the permeate water. In this case, the reverse osmosis membrane needs to be washed using a washing chemical, but it is difficult to wash the reverse osmosis membrane due to its structure.

In order to solve the above problem, the present disclosure is intended to wash the reverse osmosis membrane using bubbles. In the present disclosure, the washing liquid is stored in a washing liquid storage tank 18, and the washing liquid is fed to a line mixer 21 through a cartridge filter 20 by a washing circulation pump 19. Meanwhile, air pressurized by a compressor 21 is stored in an air storage tank 22 and then fed to the line mixer. When the washing liquid and air are mixed with each other, the air is dispersed in the washing liquid, and bubbles are thus generated.

In the reverse osmosis membrane washing operation, the reverse osmosis membrane is washed by feeding the washing liquid including the bubbles to the primary reverse osmosis pressure vessels, and contaminants between the reverse osmosis membranes are easily removed by a physical washing power caused by an explosion phenomenon of the bubbles. Therefore, there is no need to use a regenerating chemical, such as hydrochloric acid or caustic soda, which is essential in a pure water production device using an ion-exchange resin method according to the related art.

The method for reusing wastewater of the present disclosure may further include a primary pre-treatment operation and a secondary pre-treatment operation prior to the primary reverse osmosis operation. The primary pre-treatment operation includes a operation of removing floating substances included in the wastewater in a sand filtration device 2 and a operation of removing organic substances in an activated carbon adsorption device 3 and discharging primary pre-treated water from the activated carbon adsorption device 3, and the primary pre-treated water is temporarily stored in a primary pre-treatment tank 4.

The secondary pre-treatment operation is performed in an ultrafiltration device 6, and includes a operation of completely removing fine particles included in the primary pre-treated water when the primary pre-treated water is fed to the ultrafiltration device by an ultrafiltration feed pump 5. Secondary pre-treated water discharged through the secondary pre-treatment operation is temporarily stored in a secondary pre-treatment tank 7.

The secondary pre-treated water is fed to the primary reverse osmosis pressure vessels through the primary reverse osmosis high-pressure pump 10 as described above, and pure water is produced through the primary reverse osmosis operation and the secondary reverse osmosis operation.

In the present disclosure, the primary reverse osmosis operation may include a primary first stage reverse osmosis operation and a primary second stage reverse osmosis operation. In the primary first stage reverse osmosis operation, wastewater or secondary pre-treated water is fed to a primary first stage reverse osmosis pressure vessel through the primary reverse osmosis high-pressure pump, and primary permeate water from which ions are removed by reverse osmosis and primary concentrated water are discharged. The primary permeate water is fed to the secondary reverse osmosis pressure vessels through a secondary reverse osmosis high-pressure pump, and the primary concentrated water is fed to a primary second stage reverse osmosis pressure vessel.

In the primary second stage reverse osmosis operation, ions included in primary concentrated water are removed by reverse osmosis, and primary permeate water and primary concentrated water are discharged. The primary permeate water is fed to the secondary reverse osmosis pressure vessels through the secondary reverse osmosis high-pressure pump, and the primary concentrated water is discharged to the outside after transferring a surplus pressure to an energy recovery device described below.

A booster pump 12 of the energy recovery device and a turbine 14 of the energy recovery device may exist between the primary first stage reverse osmosis pressure vessel and the primary second stage reverse osmosis pressure vessel, such that an energy recovery operation may be performed. The primary concentrated water discharged in the primary second stage reverse osmosis operation rotates the turbine of the energy recovery device to operate the booster pump of the energy recovery device, and the primary concentrated water pressurized by the booster pump of the energy recovery device is fed to the primary second stage reverse osmosis pressure vessel. Therefore, separate energy for operating the booster pump of the energy recovery device is not required, and power consumption may thus be saved.

In the method for reusing wastewater of the present disclosure, the secondary reverse osmosis operation may include a secondary first stage reverse osmosis operation and a secondary second stage reverse osmosis operation. In the secondary first stage reverse osmosis operation, primary permeate water is fed through the secondary reverse osmosis high-pressure pump, and pure water from which ions are removed by reverse osmosis and secondary concentrated water are discharged. In addition, ions included in the secondary concentrated water are removed by reverse osmosis in the secondary second stage reverse osmosis operation, and the pure water produced at this time is stored in a storage tank together with the pure water produced in the secondary first stage reverse osmosis operation and used as industrial water such as cleaning water for a cold rolled product.

Meanwhile, the secondary concentrated water discharged in the secondary second stage reverse osmosis operation may be fed to the primary reverse osmosis operation again through the primary reverse osmosis high-pressure pump.

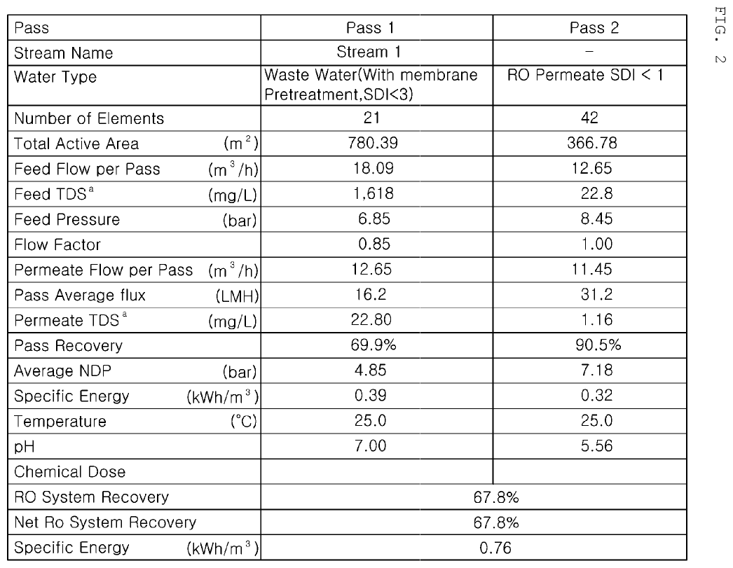

In the present disclosure, the reverse osmosis operation is performed over several orders so as to improve the quality of pure water to be finally produced. Referring to FIG. 2, total dissolved solids (TDS) in the wastewater to be fed is 1.618 mg/L, and TDS in the primary permeate water is 22.80 mg/L, and TDS in the secondary permeate water is 1.16 mg/L, which means that TDS of the permeate water is decreased, as the reverse osmosis order is repeated.

In addition, the reverse osmosis operation is performed in multiple stages at each order so as to improve a recovery rate of pure water and to reduce a discharge amount of concentrated water. The pure water produced according to the present disclosure has an electrical conductivity of 5 μS/cm or less.

In the present disclosure, it is disclosed that the reverse osmosis operation is performed only up to the secondary reverse osmosis operation, but the present disclosure is not limited thereto, and the reverse osmosis operation may include a primary reverse osmosis operation or secondary or more reverse osmosis operations.

An apparatus for reusing wastewater according to another exemplary embodiment in the present disclosure will be described.

The apparatus for reusing wastewater of the present disclosure includes: a primary reverse osmosis pressure vessel separating wastewater and discharging primary concentrated water and primary permeate water; a secondary reverse osmosis pressure vessel separating the primary permeate water and discharging secondary concentrated water and pure water; and a line mixer generating bubbles by mixing air fed from an air storage tank and a washing liquid with each other, wherein the method for reusing wastewater described above is performed.

Wastewater pressurized by a primary reverse osmosis high-pressure pump is fed to the primary reverse osmosis pressure vessels, and the wastewater is discharged as primary permeate water from which ions are removed by reverse osmosis in the primary reverse osmosis pressure vessels and primary concentrated water.

The primary permeate water is fed to the secondary reverse osmosis pressure vessels and is discharged as pure water after removing trace amounts of ions included in the primary permeate water by reverse osmosis. Secondary concentrated water is also discharged together with the pure water from the secondary reverse osmosis pressure vessels, and the secondary concentrated water is fed to the primary reverse osmosis pressure vessels again together with wastewater.

Meanwhile, the line mixer is provided to wash a reverse osmosis membrane of the present disclosure. In the line mixer, bubbles are generated by mixing air fed from the air storage tank and a washing liquid with each other, and the washing liquid including the bubbles is injected into the primary reverse osmosis pressure vessels to remove contaminants between the reverse osmosis membranes.

The apparatus for reusing wastewater of the present disclosure may further include a primary pre-treatment device and a secondary pre-treatment device. The primary pre-treatment device includes a sand filtration device removing floating substances included in the wastewater and an activated carbon adsorption device removing organic substances. Meanwhile, the secondary pre-treatment device includes an ultrafiltration device. In the ultrafiltration device, fine particles remaining in primary pre-treated water are removed and secondary pre-treated water is discharged.

The secondary pre-treated water is fed to the primary reverse osmosis pressure vessels through the primary reverse osmosis high-pressure pump, and pure water is produced through the primary reverse osmosis pressure vessels and the secondary reverse osmosis pressure vessels.

In the present disclosure, the primary reverse osmosis pressure vessel may include a primary first stage reverse osmosis pressure vessel and a primary second stage reverse osmosis pressure vessel. The wastewater or secondary pre-treated water is fed to the primary first stage reverse osmosis pressure vessel through the primary reverse osmosis high-pressure pump, and primary permeate water from which ions are removed by reverse osmosis and primary concentrated water are discharged. The primary permeate water is fed to the secondary reverse osmosis pressure vessels through a secondary reverse osmosis high-pressure pump, and the primary concentrated water is fed to the primary second stage reverse osmosis pressure vessel.

Ions included in the primary concentrated water fed to the primary second stage reverse osmosis pressure vessel are removed by reverse osmosis. The primary permeate water from which ions are removed is fed to the secondary reverse osmosis pressure vessels, and the primary concentrated water is discharged to the outside after transferring a surplus pressure to an energy recovery device.

A booster pump of the energy recovery device and a turbine of the energy recovery device may exist between the primary first stage reverse osmosis pressure vessel and the primary second stage reverse osmosis pressure vessel. The primary concentrated water discharged from the primary second stage reverse osmosis pressure vessel rotates the turbine of the energy recovery device to operate the booster pump of the energy recovery device, and the primary concentrated water pressurized by the booster pump of the energy recovery device is fed to the primary second stage reverse osmosis pressure vessel. Therefore, separate energy for operating the booster pump of the energy recovery device is not required, and power consumption may thus be saved.

In the apparatus for reusing wastewater of the present disclosure, the secondary reverse osmosis pressure vessel may include a secondary first stage reverse osmosis pressure vessel and a secondary second stage reverse osmosis pressure vessel. Ions included in the primary permeate water are removed by reverse osmosis in the secondary first stage reverse osmosis pressure vessel, and pure water and secondary concentrated water are discharged from the secondary first stage reverse osmosis pressure vessel. In addition, in the secondary second stage reverse osmosis pressure vessel, ions included in the secondary concentrated water discharged from the secondary first stage reverse osmosis pressure vessel are removed by reverse osmosis, and the pure water produced at this time is stored in a storage tank together with the pure water produced in the secondary first stage reverse osmosis pressure vessel and used as industrial water such as cleaning water for a cold rolled product.

Meanwhile, the secondary concentrated water discharged from the secondary second stage reverse osmosis pressure vessel may be fed to the primary reverse osmosis pressure vessels again through the primary reverse osmosis high-pressure pump.

In the present disclosure, it is disclosed that the reverse osmosis pressure vessel is included only up to the secondary reverse osmosis pressure vessel, but the present disclosure is not limited thereto, and the reverse osmosis pressure vessel may include a primary reverse osmosis pressure vessel or secondary or more reverse osmosis pressure vessels.

### MODE FOR INVENTION

Hereinafter, exemplary embodiments of the present disclosure will be described in detail. However, the following exemplary embodiments are provided only for assisting in the understanding of the present disclosure, but are not intended to limit the present disclosure.

1. Simulation Results of Reverse Osmosis Wastewater Reuse System

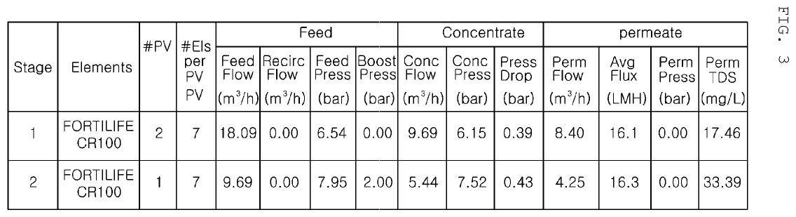

FIGS. 2 and 3 are diagrams illustrating simulation results obtained using an apparatus for reusing wastewater according to the present disclosure. Wastewater obtained through a wastewater feed pump is introduced into a primary pre-treatment device and a secondary pre-treatment device, and floating substances, organic substances, and fine particles in the wastewater are removed. Secondary pre-treated water is fed to a primary first stage reverse osmosis pressure vessel together with secondary concentrated water discharged from a secondary second stage reverse osmosis pressure vessel.

According to FIG. 3, in the present disclosure, when a feed flow rate and a feed pressure of the wastewater fed to the primary first stage reverse osmosis pressure vessel are 18.09 m³/h and 6.54 bar, respectively, a discharge rate and a flux of primary permeate water discharged from the primary first stage reverse osmosis pressure vessel are 8.40 m³/h and 16.1 LMH, respectively, total dissolved solids (TDS) in the primary permeate water discharged from the primary first stage reverse osmosis pressure vessel is 17.46 mg/L, and a discharge rate and pressure of primary concentrated water are 9.69 m³/h and 6.15 bar, respectively. The primary concentrated water is boosted at 8.45 bar thorough a booster pump of an energy recovery device, but when the primary concentrated water is fed to a primary second stage reverse osmosis pressure vessel, the pressure is decreased up to 7.95 bar.

Meanwhile, a discharge rate and a flux of primary permeate water discharged from the primary second stage reverse osmosis pressure vessel are 4.25 m³/h and 16.3 LMH, respectively, and TDS in the primary permeate water discharged from the primary second stage reverse osmosis pressure vessel is 33.39 mg/L, and a discharge rate and pressure of primary concentrated water are 5.44 m³/h and 7.52 bar, respectively. The primary concentrated water discharged from the primary second stage reverse osmosis pressure vessel is discharged at atmospheric pressure after transferring a pressure to a turbine of the energy recovery device. A total amount of the primary permeate water fed to a secondary reverse osmosis pressure vessel is 12.65 m³/h, and the amount of pure water finally produced through the secondary reverse osmosis pressure vessel is 11.45 m³/h (1.2 mg/L).

It can be confirmed through FIG. 2 that a recovery rate of the primary permeate water to the wastewater fed in a primary reverse osmosis operation is about 69.9%, and a recovery rate of the pure water to the primary permeate water fed in a secondary reverse osmosis operation is about 90.5%. In the entire reverse osmosis system of the present disclosure, a recovery rate of the pure water to the fed wastewater is 67.8%.

2. Measurement of Flux After Washing Reverse Osmosis Membrane

In the present disclosure, a flux of a new reverse osmosis membrane is 20 LMH, and in a case where the reverse osmosis membrane is contaminated with contaminants, the flux is decreased to about 16 LMH.

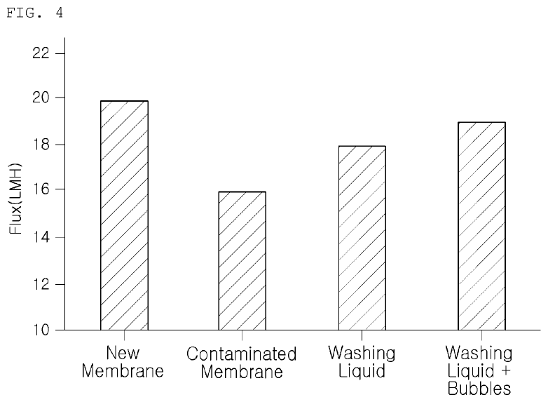

According to FIG. 4, it can be seen that in a case where the contaminated reverse osmosis membrane is washed with only a washing liquid, a flux of the reverse osmosis membrane is 18 LMH, but in a case where the reverse osmosis membrane is washed with a washing liquid including bubbles according to the present disclosure, a flux of the reverse osmosis membrane is increased to 19 LMH. This means that washing efficiency is improved by about 5.6% as compared with the case of washing the reverse osmosis membrane with only the washing liquid. As the washing efficiency is improved, the amount of pure water to be finally produced in the reverse osmosis system is increased, and the operating pressure of the reverse osmosis system is decreased. Thus, a pure water production cost may be saved.

3. Measurement of Pure Water Production Cost

TABLE 1

| | Industrial water | Production cost | Total |
|---|---|---|---|
| | (won/ton) | (won/ton) | (won/ton) |
| Ion-exchange | 500 | 350 | 850 |
| resin method | | | |
| Reverse osmosis | 0 | 750 | 750 |
| method | | | |

In an ion-exchange resin method which is a pure water production method according to the related art, since pure water is produced using industrial water, it costs about 850 won per ton of pure water. However, according to the wastewater reuse system using reverse osmosis of the present disclosure, wastewater is used, such that an additional cost is not incurred other than the production cost. Thus, it costs about 750 won per ton of pure water, resulting in a cost reduction effect of about 12%.

4. Results of Water Quality Analysis at Each Stage of Wastewater Reuse Process

In the case of the apparatus for reusing wastewater according to an exemplary embodiment in the present disclosure, an inflow of the wastewater is 18 to 19 m³/h (432 to 456 m³/day), and a final production amount is 10.0 to 11.5 m³/h (240 to 276 m³/day).

Table 2 shows results of water quality analysis at each stage of a wastewater reuse process. In Table 2, SF treated water and AC treated water mean wastewater passing through a sand filtration device and an activated carbon adsorption device, respectively. Two ultrafiltration devices are used in the present wastewater reuse process. Each of UF-A treated water and UF-B treated water means wastewater passing through the ultrafiltration device.

TABLE 2

| | | | | | | | | | | Electrical |
|---|---|---|---|---|---|---|---|---|---|---|
| | Concentration of ion (mg/L) | | | | | | | | | conductivity |
| | F⁻ | Cl⁻ | SO₄²⁻ | Na⁺ | K⁺ | NH₄⁺ | Ca²⁺ | Mg²⁺ | TDS | (μS/cm) |
| Raw water | 0.31 | 448.1 | 300.8 | 245.2 | 3.31 | 5.44 | 203.2 | 2.74 | 1200 | 2240 |
| SF | 0.30 | 458.8 | 305.2 | 237.7 | 3.30 | 5.28 | 203.1 | 2.78 | 1240 | 2242 |
| treated | | | | | | | | | | |
| water | | | | | | | | | | |
| AC | 0.21 | 447.7 | 298.6 | 246.6 | 6.73 | 4.65 | 199.6 | 3.29 | 1245 | 2251 |
| treated | | | | | | | | | | |
| water | | | | | | | | | | |
| UF-A | 0.30 | 445.3 | 296.0 | 241.5 | 5.50 | 2.86 | 202.6 | 2.86 | 1245 | 2238 |
| treated | | | | | | | | | | |
| water | | | | | | | | | | |
| UF-B | 0.29 | 444.7 | 298.7 | 243.5 | 5.80 | 3.00 | 204.2 | 2.99 | 1240 | 2257 |
| treated | | | | | | | | | | |
| water | | | | | | | | | | |
| Primary | — | 6.87 | 0.16 | 6.614 | 0.16 | 0.44 | 0.160 | — | 18.2 | 36.5 |
| permeate | | | | | | | | | | |
| water | | | | | | | | | | |
| Secondary | — | 0.17 | 0.15 | 0.456 | — | 0.15 | — | — | 2.54 | 3.93 |
| permeate | | | | | | | | | | |
| water | | | | | | | | | | |

It can be seen from Table 2 that an electrical conductivity of the finally produced pure water is 5 μS/cm.

5. Results of Washing Reverse Osmosis Membrane

(1) Operation Conditions of Apparatus for Reusing Wastewater in Normal State

TABLE 3

| | UF-A and | | Primary | | Secondary |
|---|---|---|---|---|---|
| | UF-B | Primary | concen- | Secondary | concen- |
| | treated | permeate | trated | permeate | trated |
| | water | water | water | water | water |
| Electrical | 2064 | 52.5 | — | 5.8 | — |
| conductivity | | | | | |
| (μS/cm) | | | | | |
| Pressure | 10.4 | 8.7 | — | 8.7 | 6.0 |
| (bar) | | | | | |
| Production | — | 10.5 | 5.9 | 10.0 | 1.1 |
| amount | | | | | |
| (m³/h) | | | | | |

The temperature of the wastewater fed to the primary reverse osmosis pressure vessel was 24.4° C. The electrical conductivity of the secondary permeate water was a value measured based on the temperature of about 24° C., and was 5.8 μS/cm.

(2) Operation Conditions of Apparatus for Reusing Wastewater After 40 Days

TABLE 4

| | UF-A and | | Primary | | Secondary |
|---|---|---|---|---|---|
| | UF-B | Primary | concen- | Secondary | concen- |
| | treated | permeate | trated | permeate | trated |
| | water | water | water | water | water |
| Electrical | 2199 | 64.1 | — | 2.3 | — |
| conductivity | | | | | |
| (μS/cm) | | | | | |
| Pressure | 14.5 | 10.1 | — | 11.5 | 6.8 |
| (bar) | | | | | |
| Production | — | 12.0 | 6.0 | 11.5 | 1.2 |
| amount | | | | | |
| (m³/h) | | | | | |

After 40 days, the pressure of the wastewater discharged from the primary first stage reverse osmosis pressure vessel was 10.0 bar, and the pressure of the wastewater fed to the primary second stage reverse osmosis pressure vessel was 11.0 bar. It can be seen from Tables 3 and 4 that as an operation time of the apparatus for reusing wastewater is passed, the reverse osmosis pressure vessel and the reverse osmosis membrane are contaminated with contaminants, resulting in an increase in operation pressure.

(3) Preparation of Washing Liquid and Washing Reverse Osmosis Membrane

When washing the reverse osmosis membrane, an organic washing agent and a slime washing agent are mixed with each other and water is added to prepare a washing liquid. A washing liquid having a washing agent concentration of 2.0 to 4.0 wt % based on a total weight of the washing liquid is used depending on a degree of contamination of the reverse osmosis membrane. Characteristics of the organic washing agent and the slime washing agent are shown in Table 5.

TABLE 5

| | Organic washing agent | Slime washing agent |
|---|---|---|
| Appearance (physical | Light yellow liquid | White powder |
| state, color, and the like) | | |
| Odor | Presence of peculiar | Odorless |
| | odor | |
| pH | 12 or more | 9 to 11 |
| Solubility | Well soluble in water | 140 g/L |
| Specific gravity | 1.21 | 0.9 to 1.2 |

A method for washing the reverse osmosis membrane according to the present disclosure will be described. 40 kg of the organic washing agent and 5 kg of the slime washing agent are mixed with each other.

Next, a washing liquid storage tank (1 m³ tank) is filled with pure water, and 45 kg of the mixed washing agent obtained by mixing the washing agents in advance is added thereto, thereby preparing a washing liquid having a concentration of 4.5 wt % based on the total weight of the washing liquid. The washing agents are evenly mixed by self-circulation, and then it is confirmed that a pH is within a range of 11 to 12.

The washing liquid is fed from the washing liquid storage tank and air is fed from the air storage tank to primarily wash the reverse osmosis membrane with the washing liquid including bubbles, and then an operation of a washing circulation pump is terminated. Thereafter, the reverse osmosis membrane is immersed for 17 hours, and the reverse osmosis membrane is secondarily washed again with the washing liquid including bubbles for 30 minutes.

After completing the secondary washing, the washing liquid in the reverse osmosis pressure vessel is completely washed using pure water.

(4) Operation Conditions After Washing Reverse Osmosis Membrane

The apparatus for reusing wastewater is operated after washing the reverse osmosis membrane, and the results are obtained as shown in Table 6. The pressure of the wastewater discharged from the primary first stage reverse osmosis pressure vessel was 9.2 bar, and the pressure of the wastewater fed to the primary second stage reverse osmosis pressure vessel was 9.9 bar. It can be seen that the primary concentrated water discharged in a primary second stage reverse osmosis operation rotates the turbine of the energy recovery device to operate the booster pump of the energy recovery device, and the primary concentrated water pressurized by the booster pump of the energy recovery device is fed to the primary second stage reverse osmosis pressure vessel, resulting in an increase in pressure.

TABLE 6

| | UF-A and | | Primary | | Secondary |
|---|---|---|---|---|---|
| | UF-B | Primary | concen- | Secondary | concen- |
| | treated | permeate | trated | permeate | trated |
| | water | water | water | water | water |
| Electrical | 2142 | 61.6 | — | 2.3 | — |
| conductivity | | | | | |
| (μS/cm) | | | | | |
| Pressure | 11.2 | 9.2 | — | 9.6 | 6.3 |
| (bar) | | | | | |
| Production | — | 12.1 | 5.6 | 11.4 | 1.3 |
| amount | | | | | |
| (m³/h) | | | | | |

It can be seen from Table 6 that the pressure of the wastewater fed to the primary reverse osmosis pressure vessel after washing the reverse osmosis membrane is decreased, which is because the contaminants of the reverse osmosis membrane are removed by the washing liquid including bubbles.

### REFERENCE SIGNS LIST

1: Wastewater feed pump 2: Sand filtration device

3: Activated carbon adsorption device 4: Primary pre-treatment tank

5: Ultrafiltration feed pump 6: Ultrafiltration device

7: Secondary pre-treatment tank 8: Reverse osmosis feed pump

9: Cartridge filter 10: Primary reverse osmosis high-pressure pump

11: Primary first stage reverse osmosis pressure vessel

12: Booster pump of energy recovery device

13: Primary second stage reverse osmosis pressure vessel

14: Turbine of energy recovery device

15: Secondary reverse osmosis high-pressure pump 16: Secondary first stage reverse osmosis pressure vessel

17: Secondary second stage reverse osmosis pressure vessel 18: Washing liquid storage tank

19: Washing circulation pump 20: Cartridge filter

21: Line mixer 22: Air storage tank

23: Compressor

1. A method for reusing wastewater, comprising:
a primary reverse osmosis operation of feeding wastewater to a primary reverse osmosis pressure vessel and discharging primary concentrated water and primary permeate water;
a secondary reverse osmosis operation of feeding the primary permeate water to a secondary reverse osmosis pressure vessel and discharging secondary concentrated water and pure water;
a bubble generation operation of generating bubbles by mixing air and a washing liquid with each other; and
a reverse osmosis membrane washing operation of washing a reverse osmosis membrane by feeding the washing liquid including the bubbles to the primary reverse osmosis pressure vessel.

2. The method of claim 1, further comprising:
a primary pre-treatment operation of discharging primary pre-treated water from which floating substances and organic substances in the wastewater are removed; and
a secondary pre-treatment operation of removing fine particles included in the primary pre-treated water and feeding the primary pre-treated water to the primary reverse osmosis pressure vessel.

3. The method of claim 1, wherein the primary reverse osmosis operation includes a primary first stage reverse osmosis operation and a primary second stage reverse osmosis operation.

4. The method of claim 3, further comprising an energy recovery operation of rotating a turbine of an energy recovery device using pressure of concentrated water discharged in the primary second stage reverse osmosis operation.

5. The method of claim 1, wherein the secondary reverse osmosis operation includes a secondary first stage reverse osmosis operation and a secondary second stage reverse osmosis operation.

6. An apparatus for reusing wastewater, comprising:
a primary reverse osmosis pressure vessel separating wastewater and discharging primary concentrated water and primary permeate water;
a secondary reverse osmosis pressure vessel separating the primary permeate water and discharging secondary concentrated water and pure water; and
a line mixer generating bubbles by mixing air and a washing liquid with each other.

7. The apparatus of claim 6, further comprising:
a primary pre-treatment device discharging primary pre-treated water from which floating substances and organic substances in the wastewater are removed; and
a secondary pre-treatment device removing fine particles included in the primary pre-treated water.

8. The apparatus of claim 6, wherein the primary reverse osmosis pressure vessel includes a primary first stage reverse osmosis pressure vessel and a primary second stage reverse osmosis pressure vessel.

9. The apparatus of claim 8, further comprising an energy recovery device whose turbine is rotated using pressure of concentrated water discharged from the primary second stage reverse osmosis pressure vessel.

10. The apparatus of claim 6, wherein the secondary reverse osmosis pressure vessel includes a secondary first stage reverse osmosis pressure vessel and a secondary second stage reverse osmosis pressure vessel.
